(19) United States
(12) Patent Application Publication
(10) Pub. No.: US 2017/0259729 A1
(43) Pub. Date: Sep. 14, 2017

(54) SYSTEM AND METHOD FOR VEHICLE SYSTEM DIAGNOSTICS, REPORTING, AND DOT COMPLIANCE

(71) Applicant: Murali X. Balasundrum, Fort Wayne, IN (US)

(72) Inventor: Murali X. Balasundrum, Fort Wayne, IN (US)

(73) Assignee: Spartan Motors, Inc., Charlotte, MI (US)

(21) Appl. No.: 15/449,695

(22) Filed: Mar. 3, 2017

Related U.S. Application Data
(60) Provisional application No. 62/305,306, filed on Mar. 8, 2016.

(51) Int. Cl. B60Q 1/00; B60Q 1/14; B60Q 1/08; B60Q 1/44; B60Q 3/217; B60Q 1/26; G07C 5/08; G07C 5/00; B60Q 1/24; B60Q 1/46; H05B 33/08; B60Q 3/30

(52) U.S. Cl. CPC B60Q 1/0064; H05B 33/0884; B60Q 1/1423; B60Q 1/085; B60Q 1/44; B60Q 3/30; H05B 33/0854; B60Q 1/2607; G07C 5/0808; G07C 5/0825; G07C 5/085; G07C 5/006; B60Q 1/245; B60Q 1/46; B60Q 3/217; G07C 5/008; B60Q 2300/122; B60Q 2300/45; B60Q 2400/40; G07C 2205/02

(57) ABSTRACT

Systems and methods of providing a DOT Lighting monitor that automatically detects when any of the exterior lights on a commercial motor vehicle fails/burns out and that alerts the driver to which one(s) is affected is provided. Each required light is monitored, and a state of an indicator corresponding to that required light is changed to notify an operator of a failure thereof.

### CROSS-REFERENCE TO RELATED PATENT APPLICATION

This patent application claims the benefit of U.S. Provisional Patent Application No. 62/305,306, filed Mar. 8, 2016, the entire teachings and disclosure of which are incorporated herein by reference thereto.

### FIELD OF THE INVENTION

This invention generally relates to government safety compliance systems, and more particularly to systems and methods for ensuring safety and government compliance of Department of Transportation (DOT) and Federal Motor Carrier Safety Administration (FMCSA) regulations regarding lighting on over-the-road vehicles.

### BACKGROUND OF THE INVENTION

In order to ensure safety on the roads for commercial vehicles and passenger vehicles, the government mandates that every lamp, reflex reflector, and conspicuity treatment (device) must be permanently attached to commercial motor vehicles in the location specified by the government, and that they must comply with all applicable requirements prescribed for them by the Federal Motor Vehicle Safety Standard 108 and the Canada Motor Vehicle Safety Standard 108 (FMVSS/CMVSS 108). The face of any device on the front/rear and sides of such commercial vehicles should be, respectively perpendicular and parallel to vehicle centerline, unless it is photometrically certified at installation angle. It is further mandated that no part of the vehicle shall prevent any device from meeting its prescribed requirements unless an auxiliary device meeting all prescribed requirements is installed.

Indeed, section 393.9 of Part 49 of the Code of Federal Regulations, entitled “Lamps operable, prohibition of obstructions of lamps and reflectors,” specifies that all lamps required by this subpart be capable of being operated at all times. This and other regulations for lights and reflectors on a commercial motor vehicle must be followed at all times that the vehicle is in operation in order to be compliant with the rules and to avoid compromised safety and the associated penalties attendant thereto.

Currently, however, there is no way for a commercial motor vehicle to detect which if any of its lights are out, other than having a person physically checking all of them. Checking the light operation consumes time and can be overlooked by operators. Further, such spot checks can only be adequately performed while the commercial vehicle is out of service, i.e. there is no reliable way for such person to know if one of the many lights required to be in operation has gone out during service.

Embodiments of the present invention provide such a system and method to ensure compliance with these government regulations and to continue to operate safely and efficiently. These and other advantages of the invention, as well as additional inventive features, will be apparent from the description of the embodiments of the present invention provided herein.

### BRIEF SUMMARY OF THE INVENTION

In one aspect, embodiments of the present invention provide systems and methods for vehicle system diagnostics, reporting, and DOT compliance.

In another aspect, embodiments of the present invention provide a DOT lighting monitor that can automatically detect when any of the exterior lights on the vehicle fail/burn out and alert the driver to which one(s) have failed/burned out. Such systems and methods avoid the commercial motor vehicle being placed out of service during a roadside DOT inspection, or being subject to infractions and fines. They also reduce chances of being stopped by legal authorities for improper lighting violation.

In accordance with embodiments of the present invention, such systems and methods help to avoid potentially hazardous conditions. Such systems and methods also help to provide greater peace of mind for driver and managers, and eliminate the need for a lighting pre-check.

In yet another aspect, embodiments of the present invention utilize the information provided by the lighting monitor system and additional sensors to provide enhanced functionality for the commercial motor vehicle. Such enhanced functionality includes one or more of intelligent high beam control, pedestrian spot lighting, brake light failure support, automatic management notification, automatic replacement ordering, headlight failure support, app integration, predictive maintenance, automatic puddle lights, cargo lights, active corning lights, and automatic headlights in an integrated and scalable solution that is both cost effective and time efficient, while increasing vehicle safety and driver comfort.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an illustration of regions of a commercial vehicle required by government regulations to have certain types, color, and number of lights for a particular type of commercial motor vehicle as related to one embodiment of the present invention;

FIG. 2 illustrates an indicator display illustrating exterior light monitoring in accordance with an embodiment of the present invention;

FIG. 3 illustrates an indicator display showing exterior light monitoring in accordance with an embodiment of the present invention;

FIG. 4 illustrates the indicator display of FIG. 3 when the embodiment of the present invention detects a failed rear light;

FIG. 5 illustrates a system-level diagram a light monitoring and control system in accordance with an embodiment of the present invention; and

FIG. 6 illustrates a system-level diagram of an automatic management notification system in accordance with an embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

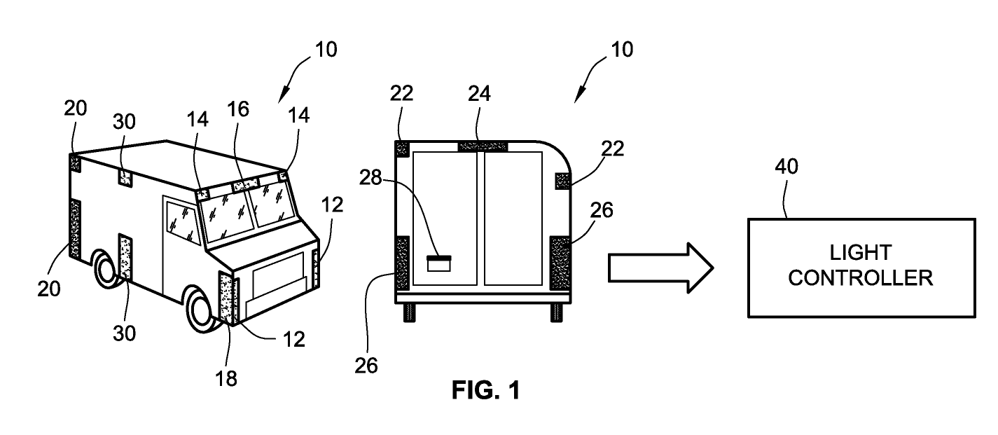

As illustrated in FIG. 1, a commercial vehicle 10 contains several lighted regions for which the government provides requirements pertaining to the type, number, and color of lights and indicators that must be included in those regions. Reference can be made to Table 1, below, as a key for each identified region on the commercial vehicle 10. As shown, each such mandated light and indicator is monitored for operational compliance with DOT requirements by the light controller 40. In one embodiment, the system and method of the present invention monitor the lights of the commercial vehicle 10 for continuity, detecting when a light fails (e.g., burns out). When a failed light is detected, the system changes the status of an indicator corresponding to that light on a panel located, e.g., in the dash of the commercial vehicle 10, such as by illuminating the indicator, extinguishing an illuminated indicator, flashing the indicator to draw the operator's attention to the situation, or changing the color of the indicator. Multiple other improvements and options are also enabled by having this system implemented, as will be discussed more fully below.

TABLE 1
Exemplary lights for commercial vehicle of FIG. 1.

| Region | Equipment | Quantity | Color |
|---|---|---|---|
| 12 | Headlights - lower beam | 2 | White |
| | Headlights - upper beam | 2 | White |
| | Front Turn Signal/Hazard Warning | 2 | Yellow |
| | Lights | | |
| 14 | Front Clearance Lights | 2 | Yellow |
| 16 | Front Marker Lights | 3 | Yellow |
| 18 | Front Side Marker Lights | 2 | Yellow |
| 20 | Rear Side Marker Lights | 2 | Red |
| 22 | Rear Clearance Lights | 2 | Red |
| 24 | Rear Marker Lights | 3 | Red |
| 26 | Brake Lights | 2 | Red |
| | Tail Lights | 2 | Red |
| | Rear Turn Signal/Hazard Warning | 2 | Red or Yellow |
| | Lights | | |
| | Backup Light | 1 | White |
| 28 | License Plate Light(s) | 1 | White |
| 30 | Intermediate Side Marker Lights | 2 | Yellow |

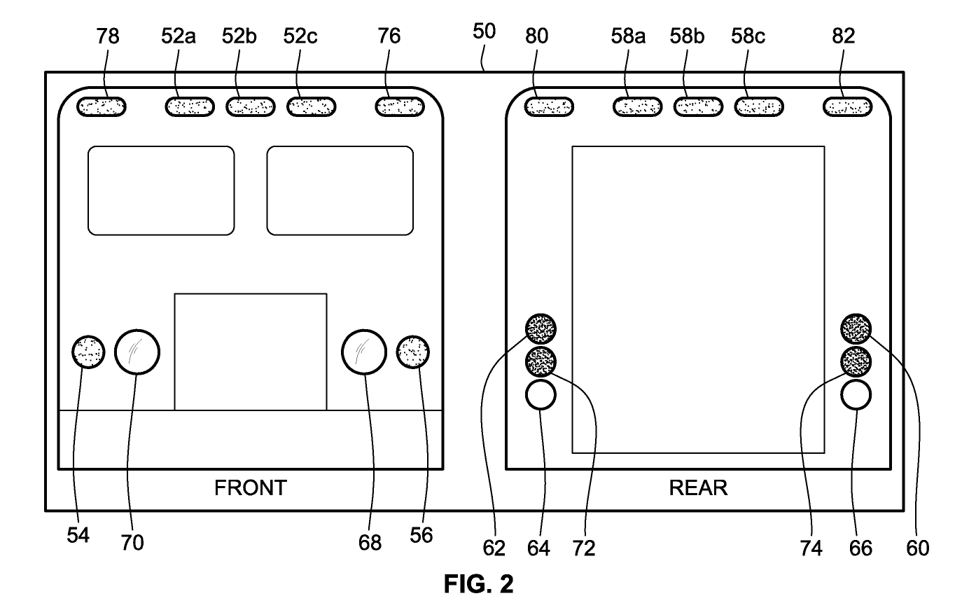

FIG. 2 illustrates an exemplary embodiment of a graphical user interface (GUI) or panel indicator, hereinafter indicator display 50, to provide requisite information to the operator. The indicator display 50 can be any of a variety of suitable displays, such as a display screen in the dashboard, a tablet computer, an operator's cellular telephone, a computer monitor visible to the operator, fleet monitor, service technician, etc., a lighted board mounted on/in the dashboard, etc. As may be seen, each required light is represented by an indicator.

In one type of commercial vehicle (e.g., such as the commercial vehicle 10 shown in FIG. 1), certain inputs and outputs for each required light may be included as a minimum, and the system can easily be expanded and customized to meet each user's specific needs. In one embodiment, such as used with the indicator display 50 shown in FIG. 2, the outputs correspond to front marker lights 52a, 52b, 52c, right front turn light 54, left front turn light 56, rear marker lights 58a, 58b, 58c, right rear tail light, right rear turn light (the right rear tail light and right rear turn light, in the embodiment depicted, are contained in the same fixture 60), left rear tail light, left rear turn light (the left rear tail light and left rear turn light, in the embodiment depicted, are contained in the same fixture 62), left backup light 64, right backup light 66, left headlight 68, right headlight 70, left brake light 72, and right brake light 74. Indicator lights can also be provided for a left front clearance light 76, a right front clearance light 78, a left rear clearance light 80, and a right rear clearance light 82. Collectively, these lights may be referred to herein as “connected lights.”

Because the systems and methods disclosed herein are applicable to vehicles of a variety of sizes, which have various lighting requirements, the number of connected lights can be more or less than the number of lights listed herein. Additionally, the types of lights can be different than those listed above. In embodiments, the light controller 40 monitors at least four connected lights, such as, e.g., both front headlights and both rear brake lights. However, other combinations of connected lights are monitored by the light controller 40 in different embodiments.

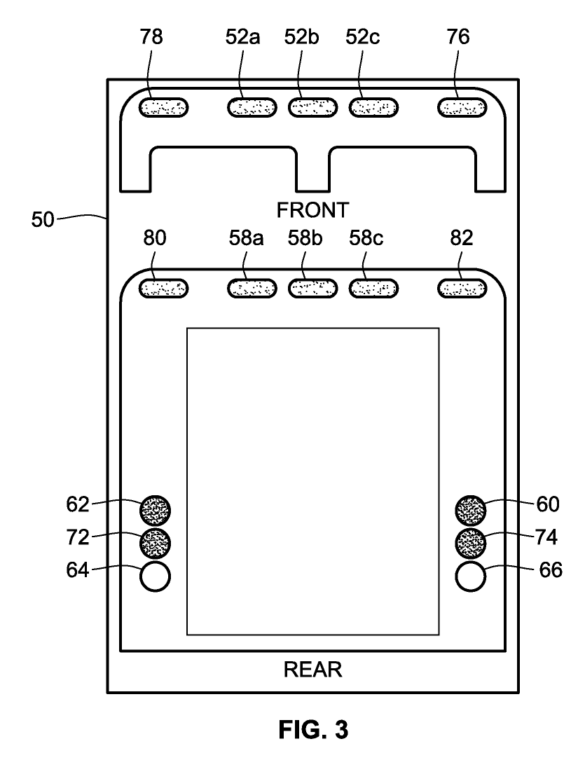

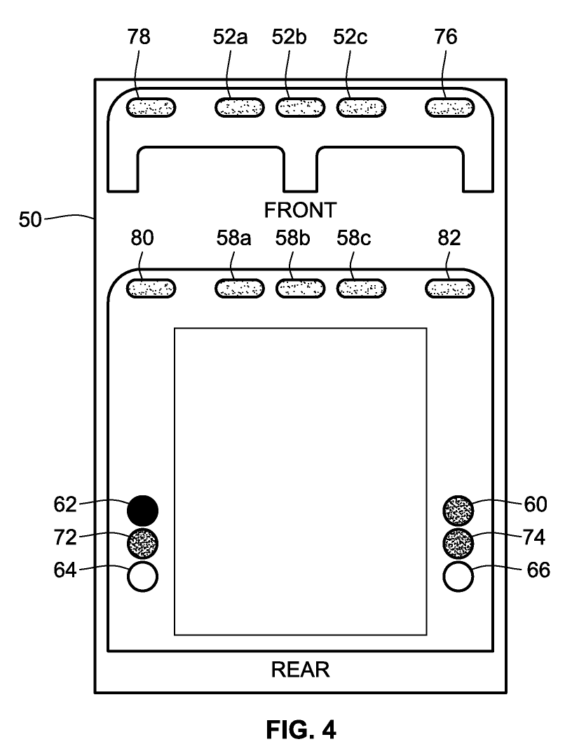

FIG. 3 and FIG. 4 illustrate an alternate embodiment of the indicator display 50 for a commercial vehicle to be used by an embodiment of the systems and methods of the present invention. As may be seen from a comparison of these two figures, FIG. 4 illustrates the failure of a light in fixture 62. As illustrated in FIG. 4, the indicator is contrasted from the other indicators by being a different color. For example, in an embodiment, the indicators are all green in color, and the indicator corresponding to a failed light changes to red. However, in other embodiments, this indicator can be a light or marker that changes its illumination state. For example the indicator changes from: (a) an on state (i.e., illuminated) state to an off state (i.e., not illuminated); (b) an off state to an on state; (c) an on state to a blinking state; or (d) an off state to a blinking state. Thus, relative to the other lights, the failed light is: (a) in an off state (i.e., not illuminated) while the other indicators are in an on state (i.e., illuminated); (b) in the on state while the other indicators are in the off state; (c) in a blinking state while the other indicators are in the on state; or (d) in the blinking state while the other indicators are in the off state.

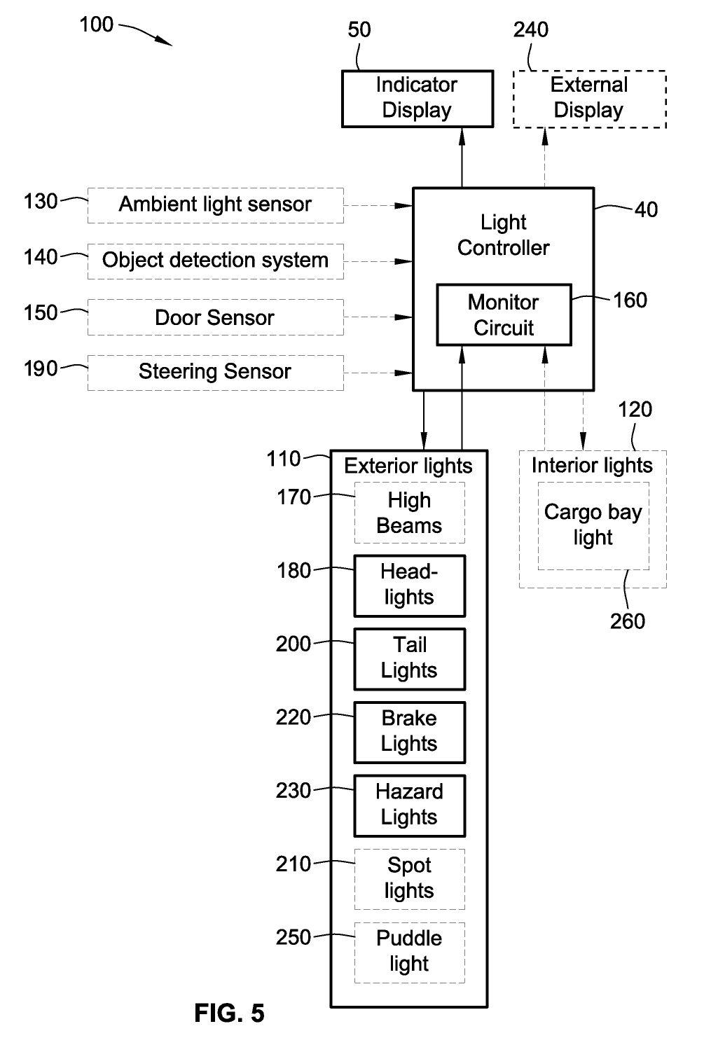

FIG. 5 provides a schematic system-level diagram of a light monitoring and control system 100. In this embodiment and other disclosed herein, the light controller 40 utilizes any of a variety of commercially available circuits or processors configured to receive and respond to electrical signals from the lights and/or other sensors connected thereto. Additionally, in embodiments, the light controller 40 is programming contained on a computer readable medium that executes commands in response to said electrical signals from the lights and/or other sensors. Thus, in the light monitoring and control system 100, information from the light controller 40 is provided to the indicator display 50 regarding the status of the exterior lights 110. The exterior lights 110 refer to those lights described above and depicted in FIGS. 2-4. Additionally, with respect to the embodiment of FIG. 5, the light controller 40 monitors a vehicle's interior lights 120, such as an interior dome light, cargo bay light, etc. Moreover, in embodiments, the light controller 40 receives information from a variety of sensors and detection devices, such as ambient light sensors 130, object detection systems 140, door sensors 150, and steering sensor 190. In this way, embodiments of the light controller 40 collect information pertaining to the vehicle's lights and surroundings and manipulate the lights to adjust the vehicle's lighting scheme accordingly.

Further, as depicted in the embodiment of FIG. 5, the light controller 40 uses a monitor circuit 160 connected to one or more lights to sense an operating parameter of the connected light, such as the current or voltage across the connected light. In an embodiment, the monitor circuit 160 determines when the current exceeds some predetermined threshold of the operating parameter. While FIG. 5 depicts a single monitor circuit 160, separate monitor circuits 160 could be used, e.g., for the exterior lights 110, the interior lights 120, or for subgroups of the exterior lights 110 and/or interior lights 120.

In embodiments, the light controller 40 indicates when a minimum or maximum current is detected by the monitor circuit 160. Such deviations outside thresholds are used to indicate a pending failure or degraded operation that requires attention. For example, if an LED array in a brake light normally draws 1 amp, the light controller 40 provides an indication when the current drops below a predetermined threshold, such as 0.75 amp, or rises above a predetermined threshold, such as 1.25 amp. In this way, the operator would be notified that potentially 25% or more of the LEDs are out or that there has been a short, and more technical information could be determined. In other embodiments, the thresholds are higher or lower, such as +/−5%, +/−10%, +/−20%, etc. In an incandescent light embodiment, the light controller 40 instead determines whether current is or is not flowing through the incandescent light or if there has been a short.

In one embodiment, the light monitoring and control system 100 also provides intelligent high beam control, i.e., automatic activation and deactivation of high beam lights 170 depending on ambient lighting conditions. With an integrated light sensor 130 directed forward, the light controller 40, in embodiments, turns on the high beam lights 170 when the path in front of the vehicle is dark enough. Additionally, in embodiments, the light sensor 130 detects the lights from an oncoming vehicle and turns off the high beam lights 170. When the oncoming vehicle has passed, the light controller 40 then reactivates the high beam lights 170. Such intelligent high beam control has the potential to increase the safety of a driver by keeping the road better illuminated and allowing the driver to use the vehicle's high beam lights 170 more than would be used via manual control.

In another embodiment, the light monitoring and control system 100 provides headlight failure support. If the headlights 180 burn out or otherwise fail, the light controller 40 switches either just the failed headlight 180 or both headlights 180 over to the corresponding high beam light or lights 170. Further, in some embodiments, the light controller 40 also reduces the lighting intensity of the high beam lights 170. In this way, the driver still has enough light to drive by at night without overly obstructing the vision of drivers in oncoming traffic.

In further embodiments, the light monitoring and control system 100 reactively controls the headlights 180. For example, a steering sensor 190 is connected to the light controller 40 such that, when the steering sensor 190 detects that the vehicle is rounding a corner, the light controller 40 causes the headlights 180 rotate into the turn, illuminating potential objects in the vehicle's path. In this way, the driver is provided better vision at night, which enhances the safety of the trip. Further, in embodiments, the light controller 40 automatically activates the headlights 180 and/or tail lights 200 when the light sensor 130 detects a predetermined level of darkness. In this way, the light controller 40 triggers the headlights 180 and tail lights 200 without user interaction, which reduces demand on the driver and maintains the driver's attention on the road.

In still another embodiment, the light monitoring and control system 100 provides pedestrian spot-lighting. In such an embodiment, the light monitoring and control system 100 has an integrated object detection system 140, such as forward collision avoidance systems. Using information collected by the object detection system 140, the light controller 40 controls a spot light 210 or causes the headlights 180 to rotate so as to illuminate a pedestrian on the road. In this way, the driver is alerted to pedestrians in the area, allowing for a better reaction time.

In a further embodiment, the light monitoring and control system 100 provides brake light failure support. If the brake lights 220 burn out or fail on the vehicle, then the light controller 40 activates the hazard lights 230 (i.e., four-way flashers). In some embodiments, the light controller 40 only activates the rear hazard lights 230, while in other embodiments, the light controller 40 activates both the front and rear hazard lights 230. In this way, following vehicles are warned that there is an issue with the vehicle in front, and the hazard lights 230 help to keep the drivers in following vehicles attentive enough to avoid a potential collision that might result from the failed brake lights 220.

Additionally, to provide monitoring flexibility, an embodiment of the present invention provides mobile or computer application integration. In such embodiments, the light monitoring and control system 100 connects to an external display device 240, such as a cellular device, tablet computer, laptop computer, desktop computer, etc. through either a wired communication means, such as USB, or wireless communication means, including forms of near field communication (such as Bluetooth® (e.g., IEEE 802.15.1)), WiFi (IEEE 802.11), etc., allowing the user to view the light controller 40 when not in the vehicle. In this way, application integration provides a user with the ability to initiate a routine check of the exterior lights 110 and/or interior lights 120, such as by triggering all or certain exterior lights 110 and/or interior lights 120 for pre- and/or post-drive checks.

In yet another embodiment, the light monitoring and control system 100 provides automatic puddle lights 250, i.e., exterior lights that illuminate at least partially around the vehicle. Door sensors 150 alert the light controller 40 that a door of the vehicle has been opened. In response, the light controller 40 activates the puddle lights 250 to illuminate the vehicle's surroundings. In embodiments, the puddle lights 250 illuminate an area adjacent to the driver's side door, passenger side door, and/or cargo bay door. In further embodiments, the puddle lights 250 are programmed to activate only near the door that has been opened, to last for a set period of time, and/or to keep the area around the vehicle illuminated until the driver returns from dropping off a package. In this way, driver safety is enhanced by reducing the chance of accidents as the result of uneven ground and other obstacles. In still further embodiments, the door sensors 150 are used to automatically activate cargo bay lights 260 when the vehicle's interior or rear cargo door is opened. In such embodiments, the system automatically turns on the interior cargo bay lights 260 when the interior or rear cargo door is opened. In this way, both efficiency and safety are enhanced as the driver can quickly get to any needed items while reducing fumbling.

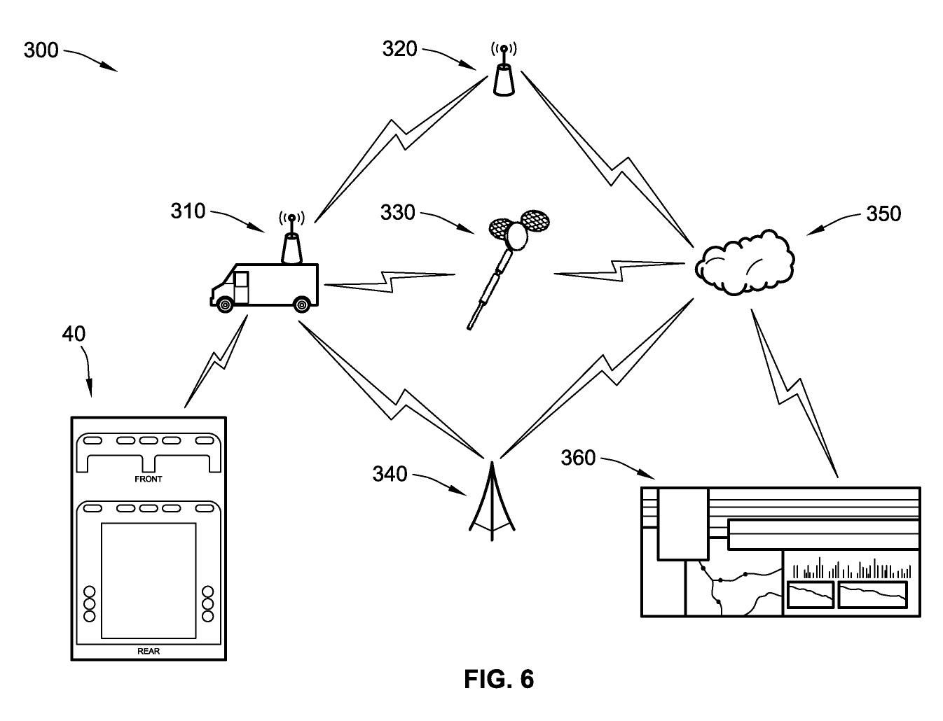

As illustrated in FIG. 6, embodiments of the present invention operate as an integral part of an automatic management notification system 300. Such a system allows the light controller 40 to communicate from a connected vehicle 310 (e.g., such as the commercial vehicle 10 of FIG. 1), through an available communication medium, e.g., WiFi hotspot 320, satellite 330, or cellular communication 340, then through an internet cloud 350, to a fleet management system 360. When tied into a fleet management system 360, the light controller 40 automatically notifies management and/or service technicians when a light goes out. This reduces downtime by ensuring service is ready to take care of the problem as soon as the vehicle returns from its runs.

In embodiments, the management notification system 300 provides predictive maintenance information. In such an embodiment, the light controller 40 tracks the timing of failures, allowing the light controller 40 to calculate the mean time before lights burn out. In embodiments, the mean time before failure is based on engine hours, run time, miles, or another metric. In this way, fleet managers are provided a better idea of when lights actually burn out. Accordingly, lights are replaced closer to the end of their usable life, thereby reducing waste but without sacrificing safety. In exemplary embodiments, the fleet management system 360 compares current service time of a light to the mean time before failure and alerts the operator, manager, and/or service technician that the life of the light has been, e.g., 75%, 90%, 95% etc., expended and replacement is likely imminent.

Further, in some embodiments, such an automatic management notification system 300 provides automatic replacement ordering. For example, when the system 300 is tied into a fleet management system 360, the light controller 40 sends a request for a new light back to a fleet management office. There the request is automatically run against a bill of material for the lights and the right part is placed on order within minutes of the part's failure on the connected vehicle 310. This helps to reduce any connected vehicle 310 downtime and to maintain an appropriate level of replacement parts in the shop.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non- claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system of maintaining compliance with lighting requirements for a motor vehicle, comprising:
a light controller configured to monitor each connected light on the motor vehicle; and
an indicator display having an indicator corresponding to each of the connected lights on the motor vehicle; and
wherein a state of the indicator is changed when the light controller detects a failure of the corresponding connected light.

2. The system of claim 1, wherein each indicator is a light capable of being in an off state and an on state; and
wherein the light changes from the off state to the on state when the light controller detects a failure of the corresponding connected light or the light changes from the on state to the off state when the light controller detects a failure of the corresponding connected light.

3. The system of claim 1, wherein each indicator is a light capable of being in a blinking state; and
wherein the light changes from an on state or an off state to the blinking state when the light controller detects a failure of the corresponding connected light.

4. The system of claim 1, wherein the connected lights include at least four lights selected from the group consisting of right front turn light, left front turn light, right rear tail light, right rear turn light, left rear tail light, left rear turn light, left headlight, right headlight, left brake light, and right brake light.

5. The system of claim 1, wherein the light controller is configured detect a failure of each connected light when an operating parameter of each connected light exceeds a threshold range.

6. The system of claim 5, wherein the operating parameter is a current through the connected light.

7. The system of claim 6, wherein the light controller detects a failure if the current through the connected light exceeds the threshold range of +/−25% of a normal operating current.

8. The system of claim 1, wherein the connected lights include two front headlights, wherein each of the two front headlights has a corresponding high beam light, and wherein the corresponding high beam light is activated when the light controller detects a failure of either of the two front headlights.

9. The system of claim 8, wherein a lighting intensity of the corresponding high beam light is reduced when activated in response to the failure of either of the two front headlights.

10. The system of claim 1, further comprising an ambient light sensor;
wherein the connected lights include two front headlights; and
wherein the two front headlights are activated when the ambient light sensor detects that ambient light has reached a predetermined darkness threshold.

11. The system of claim 1, further comprising an ambient light sensor;
wherein the connected lights include two front high beam lights;
wherein the two front high beam lights are activated when the ambient light sensor detects that ambient light has reached a predetermined darkness threshold; and
wherein the two front high beam lights are deactivated when the ambient light sensor detects headlights from an oncoming vehicle.

12. The system of claim 1, wherein the connected lights include two front headlights pointed initially in a forward direction with respect to the motor vehicle and wherein, during a turn taken by the motor vehicle, the two front headlights rotate from pointing in the forward direction towards a direction of the turn.

13. The system of claim 1, wherein the connected lights include a right brake light and a left brake light and wherein the light controller activates at least two rear hazard lights of the motor vehicle when the monitor system detects a failure in either one or both of the right brake light and left brake light.

14. The system of claim 1, wherein the light controller detects when a door of the motor vehicle is opened and, in response to the opening of the door, an exterior light is activated that illuminates at least a portion of the ground proximal to the opened door of the motor vehicle.

15. The system of claim 1, wherein the light controller detects when a cargo door of the motor vehicle is opened and, in response to the opening of the cargo door, an interior light is activated that illuminates a cargo hold of the motor vehicle.

16. The system of claim 1, further comprising an object avoidance system configured to detect the presence of pedestrians in or near a path of movement of the motor vehicle, wherein, when the object avoidance system detects the presence of one or more pedestrians, an exterior light is directed at and illuminates the one or more pedestrians.

17. The system of claim 1, wherein the exterior light is selected from the group consisting of front headlights of the motor vehicle, a spotlight mounted to the motor vehicle, and high beam lights of the motor vehicle.

18. The system of claim 1, further comprising
an ambient light sensor;
an object avoidance system configured to detect the presence of pedestrians in or near a path of movement of the motor vehicle; and
wherein the connected lights include a right brake light, a left brake light, and two front headlights;
wherein each of the two front headlights has a corresponding high beam light;
wherein the corresponding high beam light is activated when the light controller detects a failure of either of the two front headlights;
wherein a lighting intensity of the corresponding high beam light is reduced when activated in response to the failure of any of the at least two front headlights;
wherein the two front headlights and the high beam lights are activated when the ambient light sensor detects that ambient light has reached a predetermined darkness threshold;
wherein the high beam lights are deactivated when the ambient light sensor detects headlights from an oncoming vehicle;
wherein the at least two front headlights are pointed initially in a forward direction with respect to the motor vehicle and wherein, during a turn taken by the motor vehicle, the two front headlights rotate from pointing in the forward direction towards a direction of the turn;
wherein the light controller activates hazard lights of the motor vehicle when the monitor system detects a failure in either one or both of the right brake light and left brake light;
wherein the light controller detects when a door of the motor vehicle is opened and, in response to the opening of the door, an exterior light is activated that illuminates at least a portion of the ground proximal to the opened door of the motor vehicle;
wherein the light controller detects when a cargo door of the motor vehicle is opened and, in response to the opening of the cargo door, an interior light is activated that illuminates a cargo hold of the motor vehicle;
wherein, when the object avoidance system detects the presence of one or more pedestrians, an exterior light is directed at and illuminates the one or more pedestrians; and
wherein the exterior light is selected from the group consisting of at front headlights of the motor vehicle, a spotlight mounted to the motor vehicle, and high beam lights of the motor vehicle.

19. A method of maintaining compliance with government lighting requirements for a motor vehicle, comprising the steps of:
monitoring each of a plurality of connected lights on the motor vehicle; and
changing a state of an indicator on an indicator display corresponding to each of the plurality of connected lights on the motor vehicle when a failure of the indicator's corresponding connected light is detected during the monitoring step.

20. The method of claim 19, wherein the step of monitoring each connected light further comprises monitoring at least the right front headlight, left front headlight, right rear tail light, left rear tail light, right brake light, and left brake light.

21. The method of claim 19, wherein the step of changing a state of an indicator further comprises changing the indicator from an off state to an on state, changing the indicator from an on state to an off state, changing the indicator from an off state to a blinking state, or changing the indicator from an on state to a blinking state.

22. The method of claim 19, wherein the step of monitoring each connected light further comprises monitoring at least a right front headlight and a left front headlight and wherein the method further comprises the step of:
activating a high beam light corresponding the right front headlight, the left front headlight, or both the right and left front headlights when a failure has been detected in either or both the right front headlight or the left front headlight.

23. The method of claim 22, wherein the step of activating a high beam light further comprises reducing a lighting intensity of the high beam light.

24. The method of claim 19, further comprising the step of:
tracking the timing of failures for each connected light; and
calculating a mean time for failure of each connected light.

25. The method of claim 18, wherein the step of tracking the timing of failures includes tracking at least one of engine hours, connected light run time, or miles driven before failure of each connected light.

26. The method of claim 19, further comprising the step of:
alerting a user that a service time of a connected light is within 90% of the mean time for failure of that connected light.

27. The method of claim 19, further comprising the step of:
initiating a routine check of each of the plurality of connected lights using a display external to the motor vehicle.

28. A management system for a fleet of motor vehicles, the management system comprising:
a light controller configured to monitor and control a plurality of connected lights of a motor vehicle, wherein at least one light controller is provided for each motor vehicle of the fleet of motor vehicles; and
fleet management software configured to store information regarding an inventory of replacement parts and service time for the plurality of connected lights of each motor vehicle of the fleet of motor vehicles;
wherein information from the light controller regarding the plurality of connected lights of each motor vehicle is transmitted to the fleet management software such that, when the light controller detects a failure of a connected light, the fleet management software can determine whether a replacement part is presently in the inventory, and if necessary, automatically order a new replacement part.

29. The management system of claim 28, wherein the information from the light controller regarding the plurality of connected lights includes a mean time before failure for each of the connected lights.

30. The management system of claim 29, wherein the fleet management software generates an alert when the service time of a connected light is within 90% of the connected lights mean time before failure.
